(19) United States
(12) Patent Application Publication
(10) Pub. No.: US 2026/0314636 A1
(43) Pub. Date: Oct. 15, 2026

(54) PET TREAT AND METHOD OF CONTROLLING AN ANIMAL IN A VETERINARIAN PRACTICE WITH A PET TREAT

(71) Applicant: Courage Treats LLC, Harmans, MD (US)

(72) Inventors: Jodi Miller, Harmans, MD (US); Tara Klimovitz, Harmans, MD (US)

(73) Assignee: Courage Treats LLC, Harmans, MD (US)

(21) Appl. No.: 19/175,209

(22) Filed: Apr. 10, 2025

(51) Int. Cl. A23K 10/30; A01K 15/02; A23K 10/20; A23K 20/105; A23K 20/22

(52) U.S. Cl. CPC A23K 10/30; A01K 15/026; A23K 10/20; A23K 20/105; A23K 20/22

(57) ABSTRACT

A pet treat for controlling an animal in a veterinarian practice includes a gluten-free flour blend, a binder, a natural sweetener, a leavening agent, a natural preservative, and natural flavoring. The gluten-free flour blend is designed to provide structural integrity and a soft consistency. The binder is designed to enhance chewiness and texture. The natural sweetener is designed enhance flavor and maintain softness while is safe for animal consumption. The leavening agent is designed to leaven the gluten-free flour blend to produce a lighter texture. The natural preservative is designed to extend shelf life while being safe for animal consumption. The natural flavoring is designed to enhance taste and aroma while being safe for animal consumption. The pet treat is elongated and has a soft texture suitable for animals of any age, tooth health, and bite strength, and is sufficiently firm for breaking apart into bite-sized pieces.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field OF THE Invention

The disclosure relates to pet treats and snacks and more particularly pertains to a new pet treat for controlling an animal in a veterinarian practice. It is well known in animal care that pet treats can be used to provide a tasty treat to an animal, such as pets including dogs, cats, and similar animals, to reward good behavior or obedience. In addition, pet treats have an advantageous use in veterinary medicine, specifically to control an animal while performing a veterinary procedure, such as a checkup of body parts and vitals, giving an injection, drawing blood, or other common procedures for which it is useful to distract, calm, or otherwise control the animal to minimize movement or detrimental behaviors, such as barking, jumping, or biting. Unfortunately, many pet treats are small and difficult to handle, providing no visual stimulation and present a biting risk to the veterinarian. In addition, such pet treats are hard, making it difficult, if not impossible, for some animals, such older animals or those with dental issues or tooth loss. Finally, many are made with unhealthy artificial ingredients. The new pet treat solves these problems with a long stick that is soft and made of all-natural ingredients. The larger treat provides visual stimulation for the animal, allows easy handling by the user, such as one-handed use, and is sufficiently soft and safe for any animal of any age, size, and health condition.

### (2) Description of Related Art Including Information Disclosed Under 37 CFR 1.97 and 1.98.

The prior art relates to pet treats and snacks. The prior art, as best understood, does not disclose a pet treat for controlling an animal in a veterinarian practice that includes a gluten-free flour blend, a binder, a natural sweetener, a leavening agent, a natural preservative, and natural flavoring, wherein he pet treat is elongated and has a soft texture suitable for animals of any age, tooth health, and bite strength, and is sufficiently firm for breaking apart into bite-sized pieces.

### (h) BRIEF SUMMARY OF THE INVENTION

An embodiment of the disclosure meets the needs presented above in a pet treat generally comprising a gluten-free flour blend, a binder, a natural sweetener, a leavening agent, a natural preservative, and natural flavoring. The gluten-free flour blend is designed to provide structural integrity and a soft consistency. The binder is designed to enhance chewiness and texture. The natural sweetener is designed enhance flavor and maintain softness while is safe for animal consumption. The leavening agent is designed to leaven the gluten-free flour blend to produce a lighter texture. The natural preservative is designed to extend shelf life while being safe for animal consumption. The natural flavoring is designed to enhance taste and aroma while being safe for animal consumption. The pet treat is elongated and has a soft texture suitable for animals of any age, tooth health, and bite strength, and is sufficiently firm for breaking apart into bite-sized pieces.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a pet treat according to an embodiment of the disclosure.

FIG. 2 is a side view of an embodiment of the disclosure in use.

FIG. 3 is a side view of an embodiment of the disclosure in use.

FIG. 4 is a close-up view of an embodiment of the disclosure in use.

FIG. 5 is a perspective view of an alternative embodiment of the disclosure.

FIG. 6 is a perspective view of an alternative embodiment of the disclosure.

### (J) DETAILED DESCRIPTION OF THE INVENTION

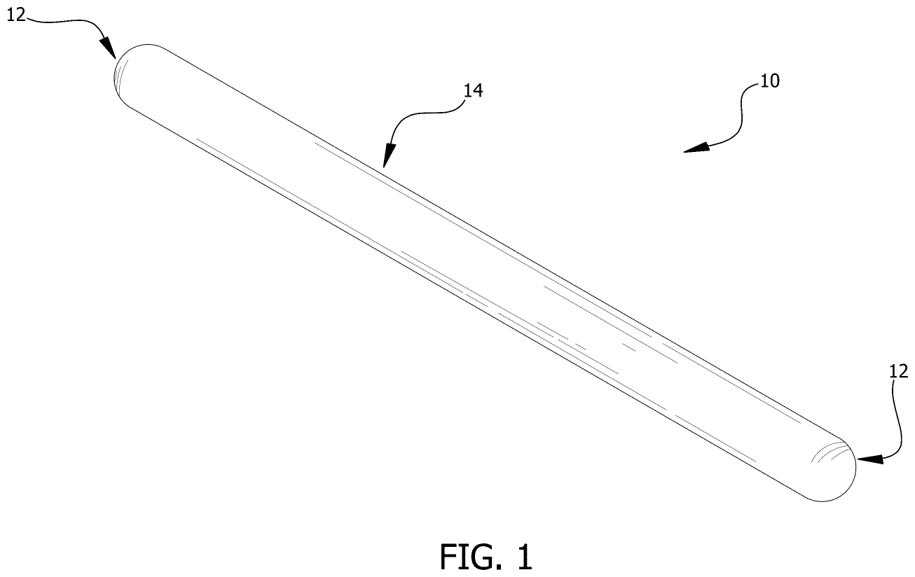

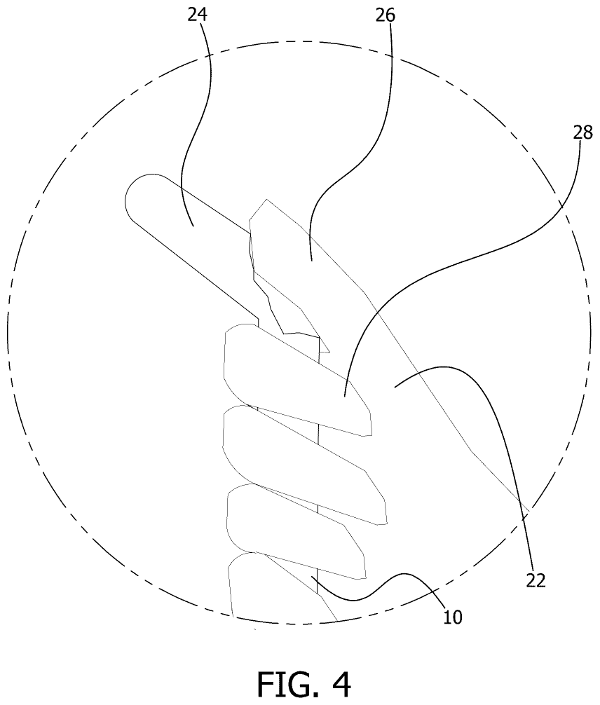

With reference now to the drawings, and in particular to FIGS. 1 through 6 thereof, a new pet treat embodying the principles and concepts of an embodiment of the disclosure and generally designated by the reference numeral 10 will be described.

As best illustrated in FIGS. 1 through 6, the pet treat 10 for controlling an animal in a veterinarian practice generally comprises a gluten-free flour blend, a binder, a natural sweetener, a leavening agent, a natural preservative, and natural flavoring. The gluten-free flour blend is designed to provide structural integrity and a soft consistency. The binder is designed to enhance chewiness and texture. The natural sweetener is designed enhance flavor and maintain softness while is safe for animal consumption. The leavening agent is designed to leaven the gluten-free flour blend to produce a lighter texture. The natural preservative is designed to extend shelf life while being safe for animal consumption. The natural flavoring is designed to enhance taste and aroma while being safe for animal consumption. The pet treat 10 is elongated and has a soft texture suitable for animals of any age, tooth health, and bite strength, and is sufficiently firm for breaking apart into bite-sized pieces.

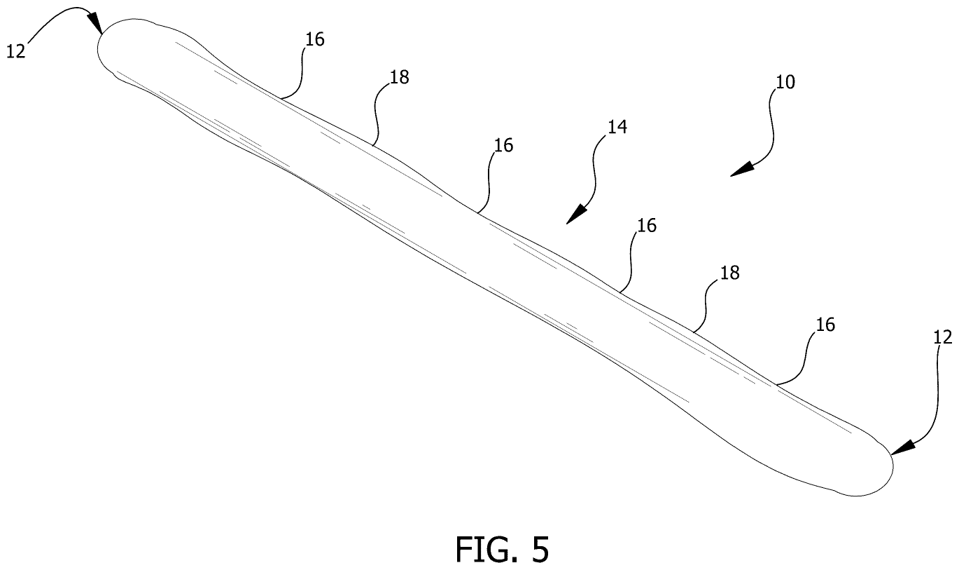

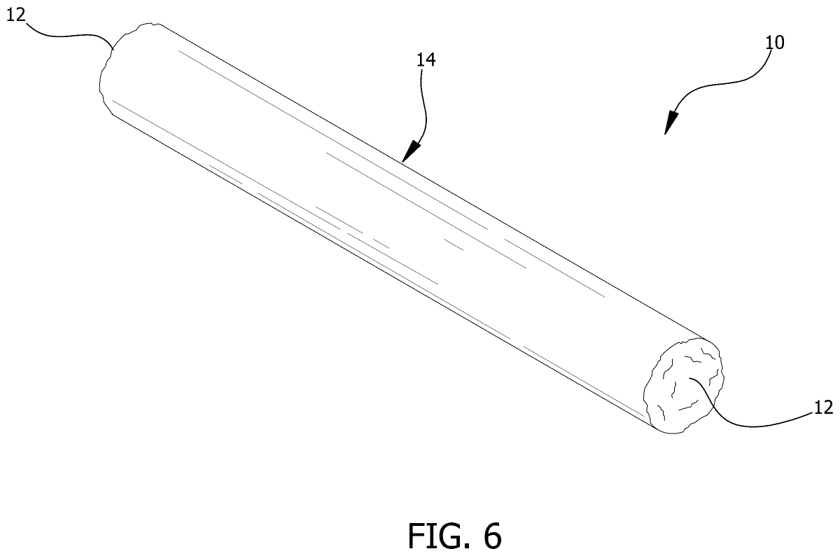

The pet treat 10 has a length in the range of 4.0 to 8.0 inches, such as 6.0 inches in one possible embodiment. The pet treat 10 is cylindrical and has a diameter in the range of 0.25 to 0.75 inches, such as 0.5 inches in one possible embodiment. In the exemplary embodiment in FIG. 1, the pet treat 10 has rounded end faces 12. In the exemplary embodiment in FIG. 5, the pet treat 10 has an irregular outer surface 14 with depressions 16 and protrusions 18. In the exemplary embodiment in FIG. 6, the pet treat 10 has flat, rough cut end faces 12. The pet treat 10 can be designed with different colors and shapes to resemble human food, such as breadsticks. Other shapes of the pet treat 10, such as square, triangular, or rectangular, could be used. The pet treat 10 could have a consistent diameter along its length between the end faces 12, or it could be irregular, tapered, or oblong or other desired shape, such that the pet treat 10 has different diameters along its length. The end faces 12 could be flat, spherical, oblong, or tapered, and could be rough or smooth.

The gluten-free flour blend includes chickpea flour, coconut flour, and tapioca starch. The binder is guar gum. The leavening agent includes baking soda and apple cider vinegar. The natural sweetener includes honey and unsweetened applesauce. The natural preservative is potassium sorbate solution. The natural flavoring includes at least one of: vanilla extract, cinnamon, and peanut butter. Other suitable natural ingredients, as well as artificial ingredients, well known in the pet snack and pet food industry are within the scope of the disclosure and could be incorporated into one or more compositions to make the pet treat 10.

In one possible embodiment, the pet treat 10 includes 20-25 wt % of the chickpea flour, 15-20 wt % of the coconut flour, 20-25 wt % of the tapioca starch, 1.5-2.5 wt % of the guar gum, 0.3-0.6 wt % of the baking soda, 20-25 wt % of the honey, 35-45 wt % of the unsweetened applesauce, 0.3-0.6 wt % of the vanilla extract, 1.5-3.0 wt % apple cider vinegar, and 0.3-0.6 wt % of the potassium sorbate solution.

In another possible embodiment, the pet treat 10 includes 18-22 wt % of the chickpea flour, 13-18 wt % of the coconut flour, 18-22 wt % of the tapioca starch, 1.5-2.5 wt % of the guar gum, 0.3-0.6 wt % of the baking soda, 15-20 wt % of the honey, 30-40 wt % of the unsweetened applesauce, 5-8 wt % of the peanut butter, 1.5-3.0 wt % of the cinnamon. 1.5-3.0 wt % of the apple cider vinegar, and 0.3-0.6 wt % of the potassium sorbate solution.

In an exemplary embodiment that has a vanilla flavor, the pet treat 10 includes 2.0 ounces of the chickpea powder, 1.5 ounces of the coconut flour, 2.0 ounces of the tapioca starch, 1.0 teaspoon of the guar gum, 0.25 teaspoon of the baking soda, 2.0 ounces of the honey, 4.0 ounces of the unsweetened applesauce, 0.25 teaspoon of the vanilla extract, 1.0 teaspoon of the cinnamon, 1.0 teaspoon of the apple cider vinegar, and 0.25 teaspoon of the potassium sorbate solution. In another exemplary embodiment that has a peanut butter flavor, the components are the same except the guar gum is reduced to 0.25 teaspoon and the vanilla extract is replaced with 1.0 teaspoon of the cinnamon and 1.0 ounce of the peanut butter. It should be understood that any numerical ranges listed herein include all values within the range, including whole numbers, tenths, and hundredths, and that all ranges disclose at least one possible or exemplary embodiment, and thus any values outside such ranges suitable for a composition of the pet treat 10 are within the scope of the disclosure.

The pet treats 10 can be made by first combining the chickpea flour, the coconut flour, the tapioca starch, the guar gum, and the baking soda to form a dry mixture. The next step is mixing the honey, the unsweetened applesauce, the vanilla extract or cinnamon and peanut butter, the apple cider vinegar, and the potassium sorbate solution to form a wet mixture. The wet mixture is then incorporated into the dry mixture to form a dough. The dough is then shaped into elongated sticks. The shaping can be done by hand or by extrusion. The shaped dough is then baked at a predetermined temperature until the exterior is set but the interior remains soft, and then the pet treats 10 are allowed to cool. In one possible embodiment, the baking temperature ranges from 275° F. to 325° F. to retain moisture and achieve a soft consistency. This process can be performed with any of the exemplary compositions disclosed herein.

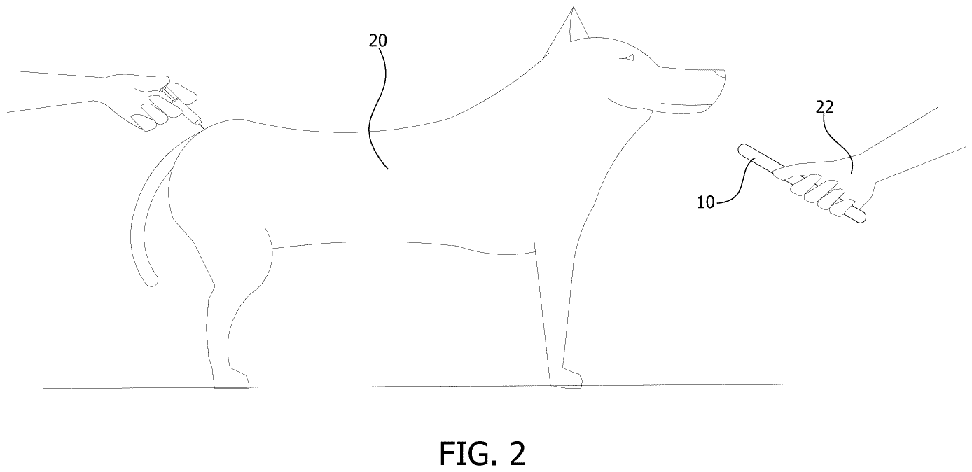

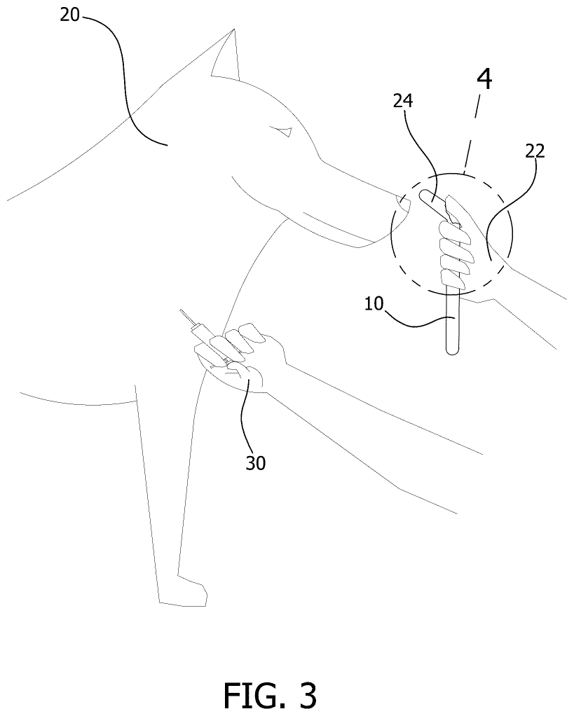

The pet treats 10 can be used in a normal manner to provide a tasty treat to an animal 20. However, the pet treats 10 have an advantageous use in veterinary medicine, specifically to control the animal 20 while performing a veterinary procedure, such as a checkup of body parts and vitals, giving an injection, drawing blood, or other common procedures for which it is useful to distract, calm, or otherwise control the animal 20 to minimize movement or detrimental behaviors, such as barking, jumping, or biting. In the exemplary embodiment in FIGS. 2 through 4, the user, such as a veterinarian, veterinary technician, or pet owner, holds the pet treat 10 adjacent a mouth of the animal 20, in this case a dog, though it should be noted that the pet treats 10 could be suitable or configured to be suitable for most any animal, including pets and other domesticated animals. The user then deforms and breaks off the end portion of the pet treat 10 to form a bite-sized piece 24. The user then feeds the bite-sized piece 24 to the animal 20 to distract the animal 20 while a veterinary task is performed, such as giving a shot as shown in FIG. 2 or drawing blood as shown in FIG. 3. The user can advance the treat in the user's hand 22 and repeatedly break off more of the bite-sized pieces 24 and feed the animal 20 until the pet treat 10 is completely used up or the veterinary task is completed.

Another advantage of the design of the pet treat 10 is that the step of deforming and breaking off the end portion of the pet treat 10 to form the bite-sized piece 24 can be performed with one hand 22 using solely a thumb 26 and at least one finger, such as the index finger 28. The user is then free to perform other tasks with the user's free hand 30, such as comforting the animal 20 by petting or patting, controlling the animal 20 by grasping a collar or leash, or performing one or more of the veterinary tasks discussed above. This frees up other staff to work on other tasks rather than requiring two persons to work with the animal 20.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pet treat for controlling an animal in a veterinarian practice comprising:
a gluten-free flour blend, the gluten-free flour blend being configured to provide structural integrity and a soft consistency;
a binder, the binder being configured to enhance chewiness and texture;
a natural sweetener, the natural sweetener being configured enhance flavor and maintain softness while being safe for animal consumption;
a leavening agent, the leavening agent being configured to leaven the gluten-free flour blend to produce a lighter texture;
a natural preservative, the natural preservative being configured to extend shelf life while being safe for animal consumption; and
natural flavoring, the natural flavoring being configured to enhance taste and aroma while being safe for animal consumption;
wherein the pet treat is elongated and has a soft texture suitable for animals of any age, tooth health, and bite strength, and is sufficiently firm for breaking apart into bite-sized pieces.

2. The pet treat of claim 1, wherein the pet treat has a length in the range of 4.0 to 8.0 inches.

3. The pet treat of claim 1, wherein the pet treat has a diameter in the range of 0.25 to 0.75 inches.

4. The pet treat of claim 1, wherein the pet treat has flat, rough cut end faces.

5. The pet treat of claim 1, wherein the pet treat has rounded end faces.

6. The pet treat of claim 1, wherein the pet treat has an irregular outer surface with depressions and protrusions.

7. The pet treat of claim 1, wherein:
the gluten-free flour blend includes chickpea flour, coconut flour, and tapioca starch;
the binder is guar gum; and
the leavening agent includes baking soda and apple cider vinegar.

8. The pet treat of claim 1, wherein:
the natural sweetener includes honey and unsweetened applesauce;
the natural preservative is potassium sorbate solution; and
the natural flavoring includes at least one of: vanilla extract, cinnamon, and peanut butter.

9. The pet treat of claim 1, wherein the pet treat includes:
20-25. wt % of the chickpea flour;
15-20. wt % of the coconut flour;
20-25. wt % of the tapioca starch;
1.5 -2.5 wt % of the guar gum;
0.3-0.6 wt % of the baking soda;
20-25. wt % of the honey;
35-45. wt % of the unsweetened applesauce;
0.3-0.6 wt % of the vanilla extract;
1.5-3.0 wt % apple cider vinegar; and
0.3-0.6 wt % of the potassium sorbate solution.

10. The pet treat of claim 1, wherein the pet treat includes.
18-22. wt % of the chickpea flour;
13-18. wt % of the coconut flour;
18-22. wt % of the tapioca starch;
1. 5 -2.5 wt % of the guar gum;
0.3-0.6 wt % of the baking soda;
15-20. wt % of the honey;
30-40. wt % of the unsweetened applesauce;
5-8. wt % of the peanut butter;
1.5-3.0 wt % of the cinnamon;
1.5-3.0 wt % of the apple cider vinegar; and
0.3-0.6 wt % of the potassium sorbate solution.

11. The pet treat of claim 1, wherein:
the pet treat has a length in the range of 4.0 to 8.0 inches;
the pet treat has a diameter in the range of 0.25 to 0.75 inches; and
the pet treat has flat, rough cut end faces.

12. The pet treat of claim 11, wherein:
the gluten-free flour blend includes chickpea flour, coconut flour, and tapioca starch;
the binder is guar gum;
the leavening agent includes baking soda and apple cider vinegar;
the natural sweetener includes honey and unsweetened applesauce;
the natural preservative is potassium sorbate solution; and
the natural flavoring includes at least one of: vanilla extract, cinnamon, and peanut butter.

13. The pet treat of claim 12, wherein the pet treat includes:
20-25. wt % of the chickpea flour;
15-20. wt % of the coconut flour;
20-25. wt % of the tapioca starch;
1.5-2.5 wt % of the guar gum;
0.3-0.6 wt % of the baking soda;
20-25. wt % of the honey;
35-45. wt % of the unsweetened applesauce;
0.3-0.6 wt % of the vanilla extract;
1.5-3.0 wt % apple cider vinegar; and
0.3-0.6 wt % of the potassium sorbate solution.

14. The pet treat of claim 12, wherein the pet treat includes.
18-22. wt % of the chickpea flour;
13-18. wt % of the coconut flour;
18-22. wt % of the tapioca starch;
1.5-2.5 wt % of the guar gum;
0.3-0.6 wt % of the baking soda;
15-20. wt % of the honey;
30-40. wt % of the unsweetened applesauce;
5-8. wt % of the peanut butter;
1.5-3.0 wt % of the cinnamon;
1.5-3.0 wt % of the apple cider vinegar; and
0.3-0.6 wt % of the potassium sorbate solution.

15. A method of controlling an animal in a veterinarian practice, the method comprising the steps of:
providing a pet treat comprising:
a gluten-free flour blend, the gluten-free flour blend being configured to provide structural integrity and a soft consistency;
a binder, the binder being configured to enhance chewiness and texture;
a natural sweetener, the natural sweetener being configured enhance flavor and maintain softness while being safe for animal consumption;
a leavening agent, the leavening agent being configured to leaven the gluten-free flour blend to produce a lighter texture;
a natural preservative, the natural preservative being configured to extend shelf life while being safe for animal consumption; and
natural flavoring, the natural flavoring being configured to enhance taste and aroma while being safe for animal consumption;
wherein the pet treat is elongated and has a soft texture suitable for animals of any age, tooth health, and bite strength, and is sufficiently firm for breaking apart into bite-sized pieces;
holding the pet treat adjacent a mouth of an animal;
deforming and breaking off the end portion of the pet treat to form a bite-sized piece;
feeding the bite-sized piece to the animal to distract the animal while a veterinary task is being performed;
repeating said steps of deforming, breaking off, and feeding until the pet treat is completely used up or the veterinary task is completed.

16. The method of claim 15, wherein:
said step of deforming and breaking off the end portion of the pet treat to form a bite-sized piece is performed with a first hand using solely a thumb and at least one finger of the first hand; and
the method further comprises performing at least one of a plurality of tasks with a second hand, the tasks including:
comforting the animal by petting or patting;
controlling the animal by grasping a collar or leash; and
performing the veterinary task.

17. A method of making a pet treat, the method comprising:
combining chickpea flour, coconut flour, tapioca starch, guar gum, and baking soda to form a dry mixture;
mixing honey, unsweetened applesauce, vanilla extract or cinnamon and peanut butter, apple cider vinegar, and potassium sorbate solution to form a wet mixture;
incorporating the wet mixture into the dry mixture to form a dough;
shaping the dough into elongated sticks;
baking the shaped dough at a predetermined temperature until the exterior is set but the interior remains soft; and
cooling the treats.

18. The method of claim 17, wherein the baking temperature ranges from 275 °F to 325 °F to retain moisture and achieve a soft consistency.

19. The method of claim 18, wherein:
the step of forming the dry mixture includes combining 20-25 wt % of the chickpea flour, 15-20 wt % of the coconut flour, 20-25 wt % of the tapioca starch, 1.5-2.5 wt % of the guar gum, and 0.3-0.6 wt % of the baking soda; and
the step of forming the wet mixture includes mixing 20-25 wt % of the honey, 35-45 wt % of the unsweetened applesauce, 0.3-0.6 wt % of the vanilla extract, 1.5-3.0 wt % apple cider vinegar, and 0.3-0.6 wt % of the potassium sorbate solution.

20. The method of claim 18, wherein:
the step of forming the dry mixture includes combining 18-22 wt % of the chickpea flour, 13-18 wt % of the coconut flour, 18-22 wt % of the tapioca starch, 1.5-2.5 wt % of the guar gum, and 0.3-0.6 wt % of the baking soda; and
the step of forming the wet mixture includes mixing 15-20 wt % of the honey, 30-40 wt % of the unsweetened applesauce, 5-8 wt % of the peanut butter, 1.5-3.0 wt % of the cinnamon; 1.5-3.0 wt % of the apple cider vinegar; and 0.3-0.6 wt % of the potassium sorbate solution.
